(19) United States
(12) Patent Application Publication
(10) Pub. No.: US 2003/0067390 A1
(43) Pub. Date: Apr. 10, 2003

(54) Vibrating monitor system

(76) Inventors: Karen Fitzgerald, Elma, NY (US); Domenic Thomas Gubitosi, East Aurora, NY (US); Mark H. Weppner, Williamsville, NY (US); Bryan M. Brown, East Amherst, NY (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/969,610

(22) Filed: Oct. 4, 2001

(51) Int. Cl. G08B 23/00

(52) U.S. Cl. 340/573.1; 455/414

(57) ABSTRACT

The present invention discloses a system and method for monitoring a child in a remote location by providing a monitoring system comprising two units which transmit audio signals from the child's location to the parent's location and the system vibrates when the audio signals reach a threshold level.

### BACKGROUND

1. Field

The present invention relates generally to monitor systems and more particularly to child monitor systems having a vibration element.

2. Background

When parents have a young child they typically wish to monitor the child at all times. In fact, parents want to monitor their child even when they cannot occupy the same room as the child. Child monitors, also known as nursery monitors or baby monitors, make this possible.

Traditional child monitors allow parents to monitor the activities of a child located in another part of a house by transmitting sounds associated with the child to the parents. These sounds could include the child's breathing or general sounds associated with play. The child monitors typically consist of two units, one acting as a transmitter and the other a receiver. In operation, the parents place the transmitter in relative proximity to the child and keep the receiver in close proximity to themselves. The transmitter unit receives sounds associated with the child and transmits these sounds to the receiving unit, which outputs these sounds to the parent. These sounds allow the parent to monitor the child and the parents act accordingly should the child need attention.

These traditional child monitors have a drawback, however, in that that the feature that makes them most useful has a limitation. Traditional child monitors allow parents to monitor their child by transmitting sounds associated with the child. However, outputting the sounds produced by the child can be inappropriate in certain circumstances or at times the sounds are simply inaudible and therefore ineffective. For example, outputting these sounds may be inappropriate or ineffective when the parent talks on the telephone or when a visitor is present. The parent, however, will decrease the usefulness of the device should he or she significantly decrease the volume of the monitor to remedy this problem. Alternatively, engaging in an activity that itself generates a significant amount of noise such as vacuuming or operating a dishwasher or washer/dryer, for example, makes sounds transmitted by a child monitor inaudible, also rendering it ineffective.

Consequently, a need exists for an improved child monitor system which allows parents to monitor their child using audible signals as well as alternative stimulation to alert parents that their child may need attention.

### SUMMARY

Embodiments disclosed herein address the above stated need by providing a system and method for monitoring a child in a remote location by providing a monitoring system comprising two units, one of which transmits audio signals from the child's location and the other of which receives the transmitted signals at the parent's location and which vibrates when the audio signals reach a threshold level.

### BRIEF DESCRIPTION OF THE DRAWINGS

FIG. 1 is a schematic view of a first embodiment of a monitor system of the present invention.

FIG. 2 depicts an operating mode of the monitor system of FIG. 1.

FIG. 3 is a schematic view of another example embodiment of the monitor system of FIG. 1.

FIG. 4 is a schematic view yet another example embodiment of the monitor system of FIG. 1.

FIG. 5 is a flowchart illustrating a method for monitoring a child in a remote location according to an example embodiment of the present invention.

FIG. 6 is a perspective view of an example embodiment of the monitor system of the present invention.

FIGS. 7 and 8 are frontal and side views of the local unit of the monitor system of FIG. 6.

FIGS. 9 and 10 are frontal and side views of the remote unit of the monitor system of FIG. 6.

### DETAILED DESCRIPTION

Overview

The present invention relates generally to child monitoring systems. According to various example embodiments of the present invention, a monitoring system is disclosed which transmits audible signals and includes a vibration element sensitive to audible signal levels.

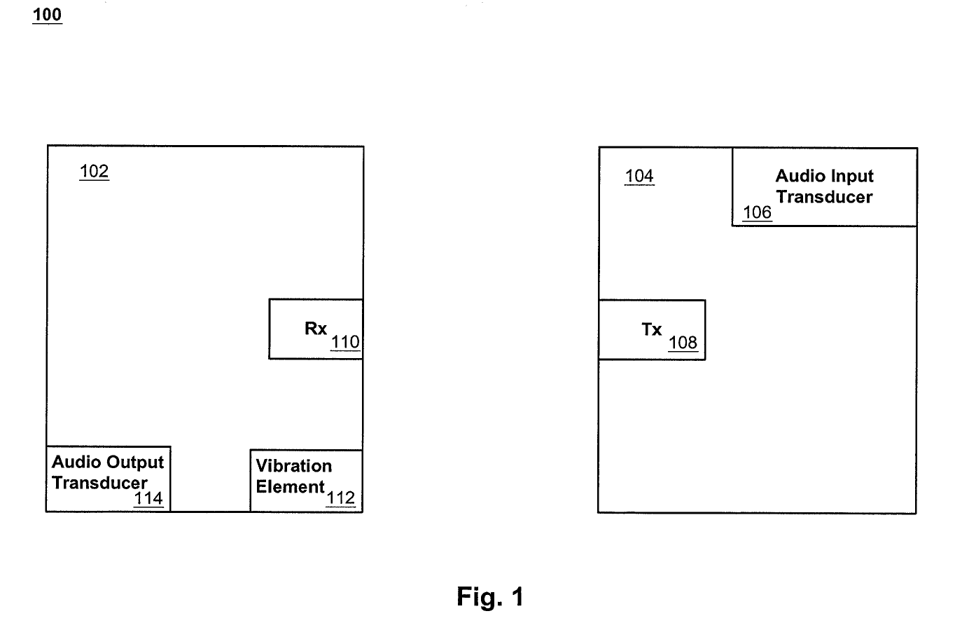

FIG. 1 schematically illustrates a monitoring system 100 according to an example embodiment of the present invention. Monitoring system 100 includes a local unit 102 and a remote unit 104. Local unit 102 includes a receiver 110, an audio output transducer 114, and a vibration element 112. Remote unit 104 includes a transmitter 108 and an audio input transducer 106.

Transmitter 108 and receiver 110 represent any transceiver hardware, software, or combination of hardware or software that transmit signals from one device to another either wirelessly or via a wired connection. Audio output transducer 114 and audio input transducer 106 represent any devices including speakers and microphones for outputting and receiving audio signals. Vibration element 112 represents any device which produces vibratory motion.

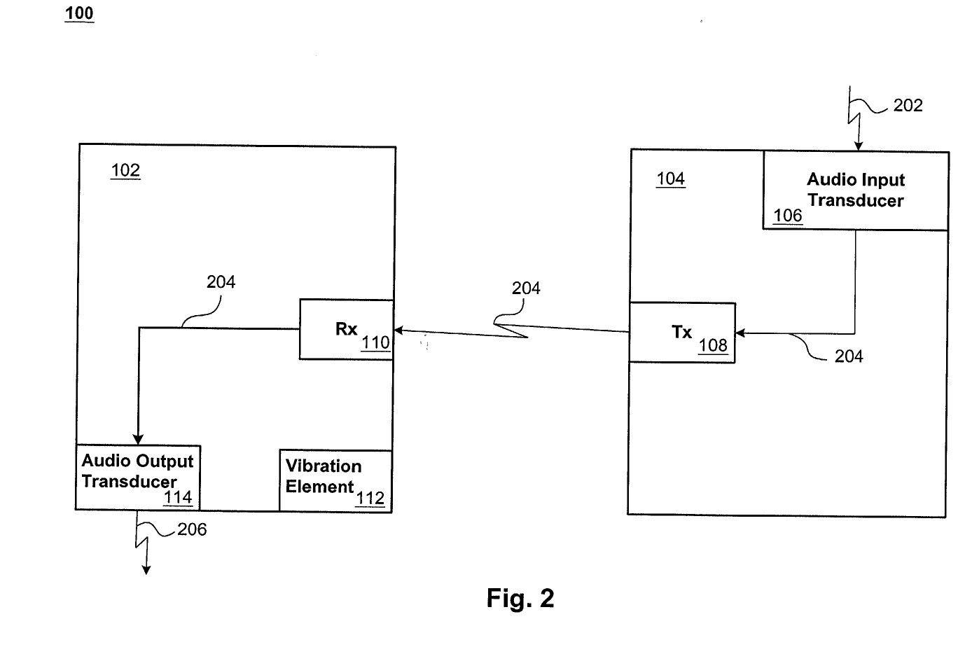

The operation of monitor system 100 is shown in FIG. 2. Audio input transducer 106 of remote unit 104 receives an audio input signal 202. Audio input transducer 106 converts audio input signal 202 into an audio signal 204. Transmitter 108 then transmits audio signal 204 to receiver 110 of local unit 102. Audio output transducer then converts audio signal 204 into an audio output signal 206. Should audio signal 204 exceed a threshold signal value vibration element 112 will activate, which causes local unit 102 to vibrate. Consequently, monitor system 100 provides both an audio output and a vibratory response to the user.

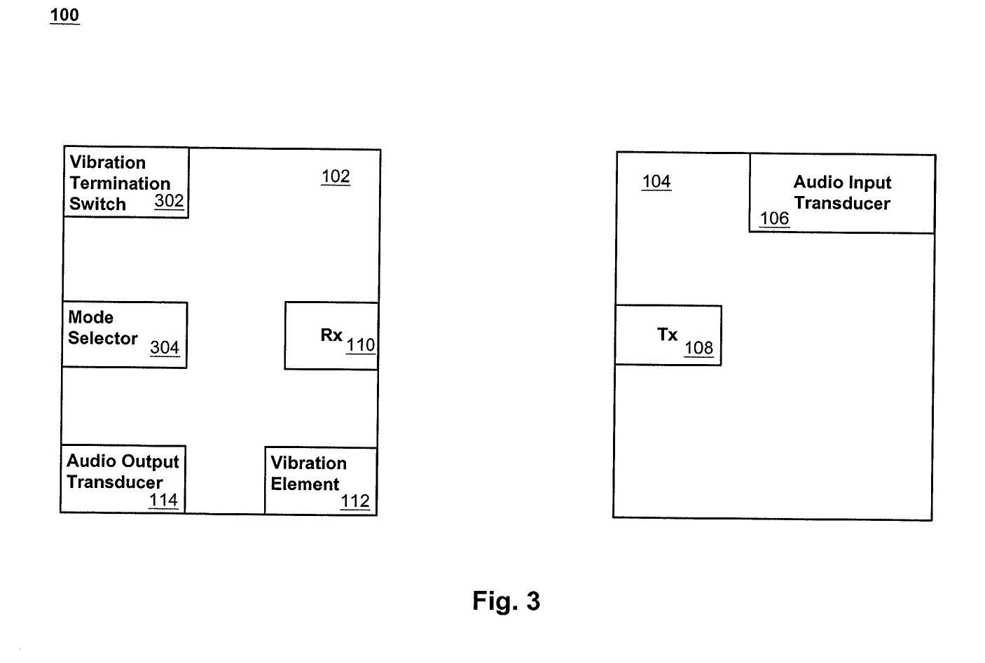

FIG. 3 schematically illustrates another example embodiment of monitor system 100 of the present invention. In this embodiment, monitor system 100 includes a vibration termination switch 302 and a mode selector 304. Vibration termination switch 302 and mode selector 304 represent any hardware, software, or combination of hardware and software which act as a switch.

In this configuration, the operation of monitor system 100 is similar to that described in connection with FIG. 2, however vibration termination switch 302 and mode selector 304 provide additional functionality. Specifically, should vibration element 112 be activated, the user may choose to stop the operation of this element by using vibration termination switch 302. In addition, this configuration allows the user to select between multiple operating modes. The user may choose to operate monitor system 100 in “audio only” mode by disabling the vibration element altogether, in which case, the user may use mode selector 304 to have monitor system 100 output only audio signals with no vibration. Alternatively, again by using mode selector 304, the user may choose to operate monitor system 100 in sound and vibration mode to both output audio signals and vibrate should the audio signals reach a certain level. Alternatively, the user may choose to operate monitor system 100 in vibration only mode in which case monitor system 100 will not output audio signals but will vibrate should those signals reach a threshold level.

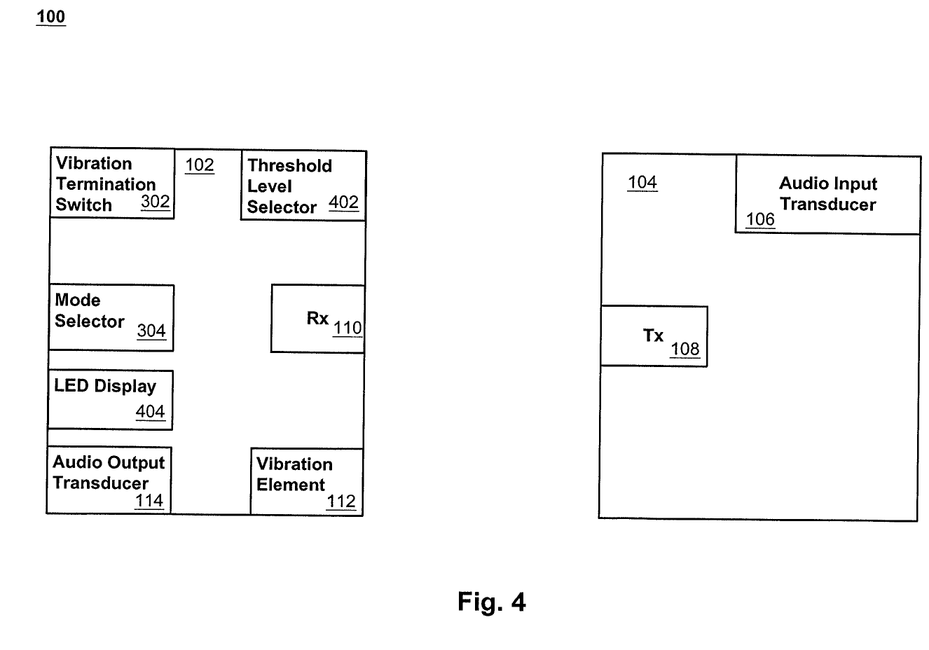

In addition to the various additional features made possible by the example embodiment of the present invention described above, FIG. 4 depicts yet another example embodiment of the present invention. This example embodiment of monitor system 100 includes a threshold level selector 402 and a display 404. Threshold level selector 402 represents any hardware, software, or combination of hardware and software which acts as a signal-level selection device. Display 404 represents any suitable display hardware, including any combination or configuration of LEDs or other light emitting sources.

The operation of the monitor system 100 shown in FIG. 4 is similar to that described in connection with FIGS. 2 and 3 but with additional functionality. Specifically, threshold level selector 402 allows the user to select the level of the audio signal at which vibration element 112 will operate. Also, display 404, in an example embodiment, consists of several LEDs, which activate at successively higher levels of the audio signal. For example, display 404 consists of 6 LEDs, the first LED is activated when the audio signal is at its lowest level and all 6 are activated when the signal is at its highest level. In one embodiment of the present invention, using threshold level selector 402, the user may set monitor system 100 to vibrate when the third LED is activated, for example.

The artisan will recognize that the additional elements described in FIGS. 3 and 4 may be implemented in any combination without departing from the spirit and scope of the present invention. Further, the monitoring system may be used to monitor children, but may also be used in any situations in which sound is generated. For example, the monitoring system could be used to monitor the ill and elderly, pets, or cars entering or exiting a driveway, for example. Monitor system 100 may also transmit video signals as well as audio signals without departing from the spirit and scope of the present invention.

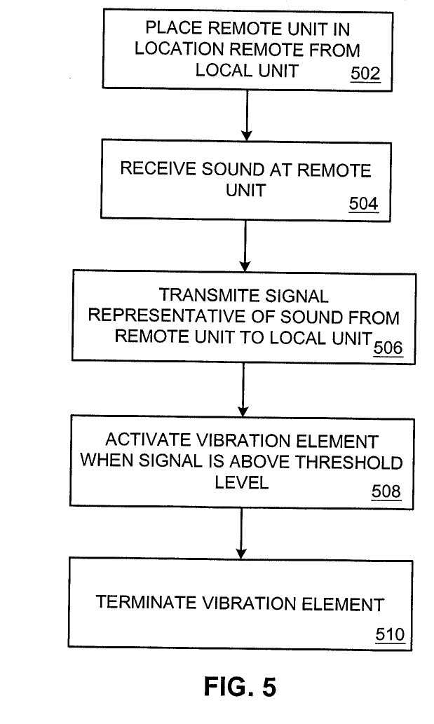

FIG. 5 is a flowchart 500 that describes the operation of an example embodiment of the present invention. In operation 502, remote unit 104 is in a location remote from local unit 102. FIGS. 1, 2, and 3 depict remote unit 104 and local unit 102 and their respective components in various configurations.

In operation 504, acoustic sound is received at remote unit 104. As shown in FIG. 2, audio input transducer 106 of remote unit 104 receives audio input signal 202.

In operation 506, a signal representing the acoustic sound is transmitted from remote unit 104 to local unit 102. As shown in FIG. 2, audio input transducer 106 of remote unit 104 receives audio input signal 202 and converts it to input signal 204 which transmitter 108 transmits to receiver 110 of local unit 102.

In operation 508, vibration element 112 is activated when input signal 204 is above a threshold level. As shown in FIG. 2, vibration element 112 will activate should input signal 204 exceed a threshold level causing local unit 102 to vibrate.

In operation 510, the vibration element is terminated after it has been activated. As shown in FIGS. 3 and 4, after vibration element 112 has been activated, the user may terminate its operation using vibration termination switch 302.

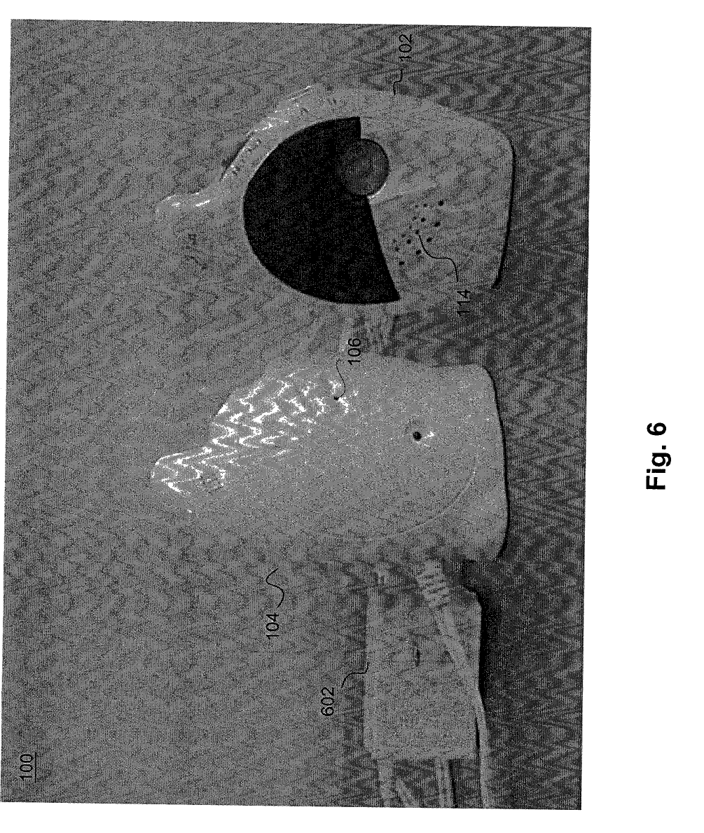

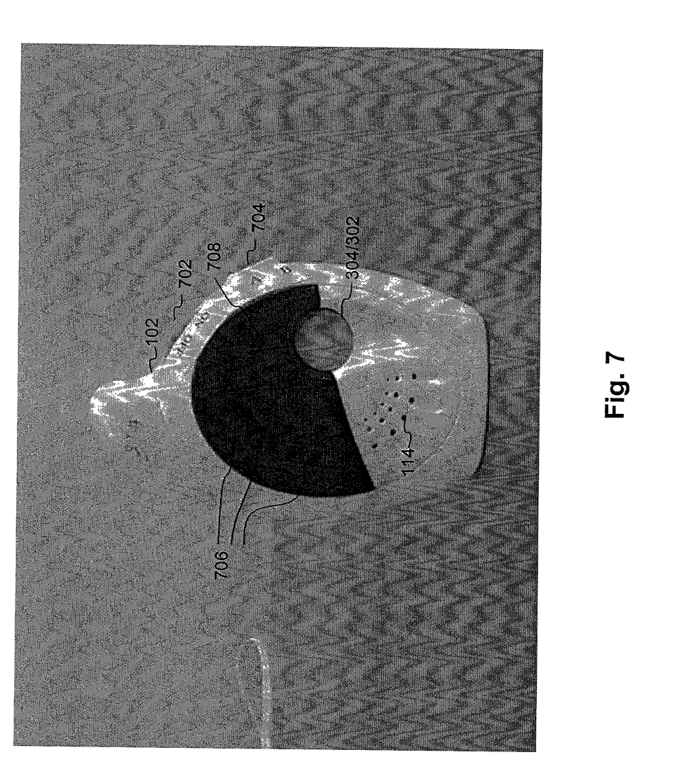

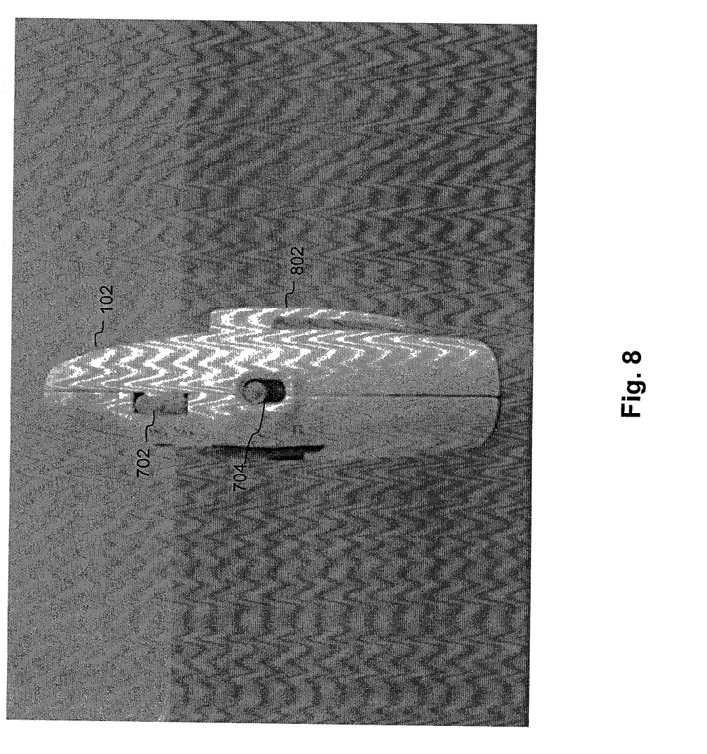

FIG. 6 depicts an exemplary implementation of the monitor system 100, illustrated schematically above, of the present invention. This example embodiment includes local unit 102, and remote unit 104. Local unit 102 includes an audio output transducer 144, which is implemented as a speaker (1″/5 cm) located behind the perforated front face of the housing of local unit 104, and, as shown in FIG. 7, several visual displays and user controls. The displays include a POWER ON/LOW BATTERY LED 708, and a sound level indicator or display 706 implemented as a series of LEDs. The user controls include an ON/OFF VOLUME switch 702, an A/B channel select switch 704, mode selector 304 and vibration termination switch 302. Local unit 102 also includes a clip 802, as shown in FIG. 8, such that local unit 102 may be worn on the person of the user.

Local unit 102 also includes a vibration element that, when activated, causes local unit 102 to vibrate. The vibration element includes a small motor driving a shaft with an eccentrically mounted weight.

Power to the electronic components of local unit 102 is supplied by a main power supply which, in this example embodiment, consists of three rechargeable AAA batteries housed in a battery compartment located in the rear housing of local unit 102, but may be any other suitable AC or DC power supply.

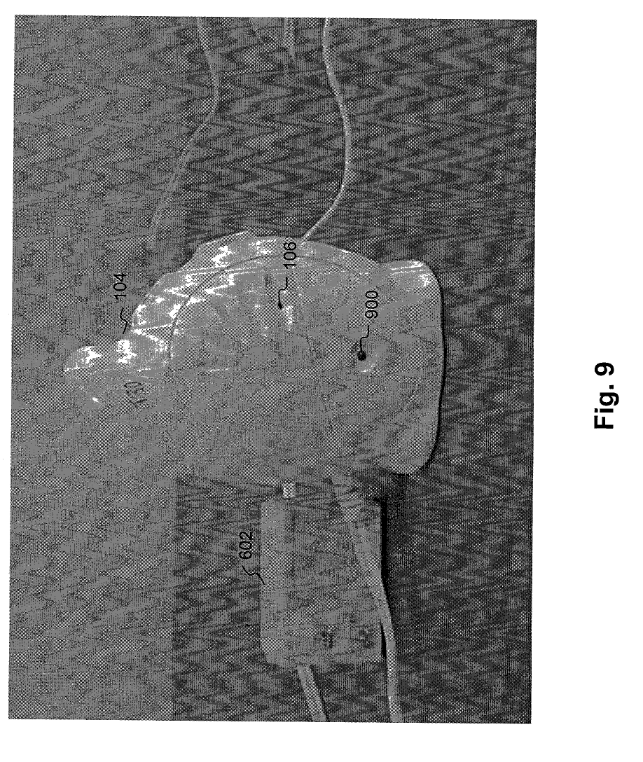

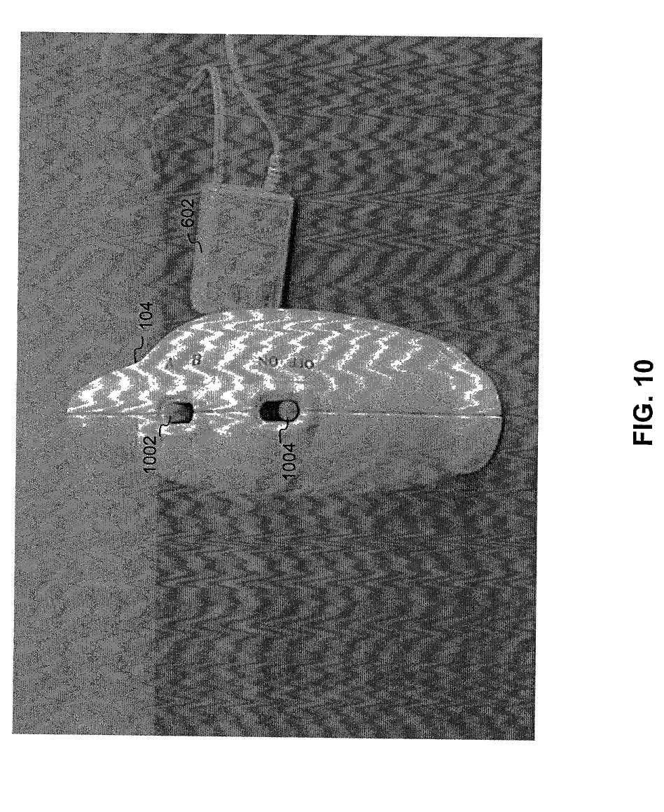

Remote unit 104 includes audio input transducer 106, which is implemented as a condenser microphone mounted on the front face of the housing of remote unit 104, AC power adapter 602, and as shown in FIGS. 9 and 10, a POWER ON LED 900, A/B channel select 1002, and ON/OFF switch 1004.

Power to the electronic components of remote unit 104 is provided by AC power adapter 602, however internal DC power (such as batteries) could also be used.

The transmitter and receiver circuitry used in the local and remote units may be any standard circuitry as could be readily selected by the artisan. One suitable implementation is a 49 MHz system available from Excel Engineering, Ltd. of Japan. Many other systems (including for example, 900 MHz systems) are available from various suppliers.

In operation, to monitor a child for example, the user places remote unit 104 in relative proximity to the child and the user either places local unit 102 in the room with the user or wears local unit 102 on his or her person using clip 802. Audio input transducer 106 of remote unit 104 receives audible inputs associated with the child and transmits them to local unit 102. Local unit 102 will then output these sounds via audio output transducer 114 such that the user may be aware of the audible activities of the child. LED display 706 includes six LEDs, which illuminate in succession depending on the audio signal level. In this example embodiment, the single LED to the lower left of LED display 706 illuminates when the audio signal is at its lowest level, and all six illuminate when the audio signal is at its greatest level. In addition, should the sounds exceed a threshold level, local unit 102 will vibrate thus providing an alternate way of alerting the user to activities of the child. In an example embodiment, when the audio signal level is such that LEDs one through three are illuminated and remain so for three seconds, local unit 102 will vibrate. This example embodiment allows the user a choice of receiving both audio output and vibration or, alternatively, vibration only by using volume control 702 to decrease the volume completely, thus muting the audio output.

Once local unit 102 begins to vibrate, the user may choose to terminate the vibration by depressing vibration termination switch 302, which, when done, disables the vibration element for one minute in this example embodiment. Also, the user may use mode selector 304 to eliminate the vibration option altogether. By doing this, the unit will then operate as a traditional child monitor by only providing audio output (in addition to the visual LED display in this example embodiment).

In an alternative implementation, the function of mode selector 304 and vibration termination switch 302 can be combined. Thus, a single switch could be used to enable or disable the vibration function (and if enabled, the user could terminate vibration once started by changing the switch to the disable position.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A monitor system comprising:
a remote unit including:
an audio input transducer for converting an acoustic input into an input signal; and
a transmitter for transmitting said input signal; and
a local unit including:
a receiver for receiving said input signal from said transmitter;
a vibration element, wherein said vibration element is activated
when said input signal is greater than a pre-determined threshold level; and
an output transducer for converting said input signal into an acoustic output.

2. The monitor of claim 1 wherein said monitor system has a first operating mode and a second operating mode wherein when said monitor system is in said first operating mode said input signal is converted into an acoustic output and wherein when said monitor system is in said second operating mode said input signal is converted into an acoustic output and said vibration element is activated when said input signal is greater than said threshold level.

3. The monitor system of claim 1 wherein said local unit further includes a vibration termination control.

4. The monitor system of claim 1 wherein said threshold level is selectively adjustable by a user.

5. The monitor system of claim 4 wherein said remote unit includes a threshold level selector for selectively adjusting said threshold level by the user.

6. The monitor system of claim 4 wherein said local unit includes a threshold level selector for selectively adjusting said threshold level by the user.

7. The monitor system of claim 1 wherein said local unit further includes a display.

8. The monitor system of claim 7 wherein said display produces visible output corresponding to a signal level of said input signal.

9. The monitor system of claim 1 wherein a vibration level of said vibration element is proportional to a signal level of said input signal.

10. The monitor system of claim 1 wherein said acoustic signal is a sound generated by a child.

11. A method for remotely monitoring an acoustic sound with a monitor having a local unit and a remote unit comprising the steps of:
placing said remote unit in a location remote from said local unit;
receiving an acoustic sound at said remote unit;
transmitting a signal representative of said acoustic sound from said remote unit to said local unit;
audibly outputting said acoustic sound at said local unit; and
activating a vibration element in said local unit when said signal is greater than a threshold level.

12. The method of claim 11 wherein said local unit further includes a vibration termination switch and wherein said method further includes the step of terminating activation of said vibration element.

13. The method of claim 11 wherein said activating step further includes the step of adjusting said threshold level.

14. The method of claim 11 wherein said method further includes the step of displaying a visible output corresponding to a signal level of said signal.
